(19) United States
(12) Patent Application Publication
(10) Pub. No.: US 2009/0221409 A1
(43) Pub. Date: Sep. 3, 2009

(54) Bag-making device

(75) Inventors: Ruediger Duwendag, Lengerich (DE); Andreas Sonntag, Muenster (DE)

Correspondence Address: JACOBSON HOLMAN PLLC, 400 SEVENTH STREET N.W., SUITE 600, WASHINGTON, DC, 20004, US

(73) Assignee: Windmoeller & Hoelscher KG

(21) Appl. No.: 12/292,958

(22) Filed: Dec. 1, 2008

Related U.S. Application Data
(63) Continuation of application No. 10/531,256, filed on Apr. 13, 2005, now abandoned.

(30) Foreign Application Priority Data
Dec. 20, 2002 (DE) 102 61 256.0

(51) Int. Cl. B31B 47/02; B31B 1/00

(52) U.S. Cl. 493/267; 493/186

(57) ABSTRACT

A bag-making device for cross base bags limits the number of quality defects resulting from the fabrication tolerances of the conveyor belt.

The device has working stations that perform working steps on bag tube sections during the bag making operation. At least one working station is equipped with a tool that is mounted on a tool roller and that runs through its working position during each rotation of the roller. The bag-making device has a conveyor system that conveys the tube sections through the working stations with conveyor belts, and a drive system that drives conveyor drive wheels and the tool rollers such that the drive wheels are driven with lesser angular speed than the tool rollers.

The invention concerns a bag-making device for cross base bags as is presented in the generic term of claim 1.

These devices are known since long and are acknowledged e.g. in the document DE 198 05 321 C1. In more recent times, there has been an increasing demand for cross base bags with small volumes. Cross base bags can have a small volume by means of a smaller base middle measurement. However, the manufacture of bags with smaller base middle measurement requires the implementation of extensive constructive changes in the means of production, primarily in bag making devices. Since the bags are conveyed at right angles to the principal axis of the tube through the working station of the bag-making device, both the working stations and also the conveyor system have to be formed narrower than they used to be so far.

One of the necessary measures is the use of narrower conveyor belts for conveying the bags through the working stations of the bag-making device. However, the conveyor belts are exposed to a considerable amount of tensile stress and run the risk of getting stretched. This tendency increases with the decreasing breadth of the conveyor belt. The result of changing the length of the conveyor belt in the operation, however, is that the bag positions in the working stations no longer correctly align with the rotary motions of the tool rollers. The tools run through their machining position when the bag is not yet or no longer located at the right place and the related working step is executed inaccurately. The resulting fabrication tolerances of the bags can result in serious quality defects in the bags e.g. leakiness and lack of durability. These consequences are highly undesirable.

For these reasons the use of conveyor belts is recommended that have at least components made of tensile-stressable material such as steel. As a rule these components of the belt are coated with a more elastic and softer material that prevents the conveyed items from damage. In this context the so-called cable cord belts must be mentioned that contain steel in their core and are usually coated with rubber.

Unfortunately conveyor belts of the described kind have fabrication tolerances. The result of these fabrication tolerances is once again imprecisions in the positioning of the bags in the machining positions and thus fabrication tolerances of the bags.

Therefore the task of the present invention is to suggest a device that restricts the quality defects that are brought about by the fabrication tolerances of the conveyor belt.

This task is solved thus:
the drive wheels of the drive system can be driven using lesser angular speed than at least a tool roller and that
the drive wheels have a larger diameter than the tool rollers.

The present invention makes use of a whole series of surprising findings. In the use of conveyor belts with components of tensile-stressable material such as steel and a softer protection and/or a softer coating, the conveying process of the bags is first determined by the tensile-stressable material.

Thus the angular speed of the transport discs and the distance of the tensile-stressable material from the axis of the transport discs are decisive for the conveying speed of the bags in the working stations.

The distance of the tensile-stressable material from the axis of the transport discs is referred to as the effective disc radius in the following. It is composed of the actual radius of the drive wheel and the thickness of the elastic, soft layer between the outer circumference of the transport disc and the tensile-stressable material. However, the thickness of this layer is subject to variations that are transferred to the effective radius of the transport discs and thus to the conveying speed.

These variations are mainly responsible for the imprecisions in the positioning of the bags in the working stations. By the measures in accordance with the invention, the relative portion of the variations in the thickness of the elastic, soft layer between the outer circumference of the transport disc and the tensile-stressable material is reduced to the effective radius of the transport disc and thus to the conveyance speed.

What proves to be particularly advantageous is a configuration in which the ratio of the angular speed of the drive wheels to the angular speed of the processing rollers amounts to ⅔. Due to this ratio of the angular speed of ⅔, the speed droop of the conveyor belt also reduces by the factor ⅔ as compared to when the drive wheels have the same angular speed as the processing rollers.

It is advantageous to provide a drive system that with the help of a bevel gear diverges torque moment for at least one drive wheel from a line shaft (vertical shaft with bevel gears) and transfers it onto the drive wheel via a planetary gear placed underneath.

An example of the design of the invention is presented in the drawings and the objective description.

The individual figures illustrate:

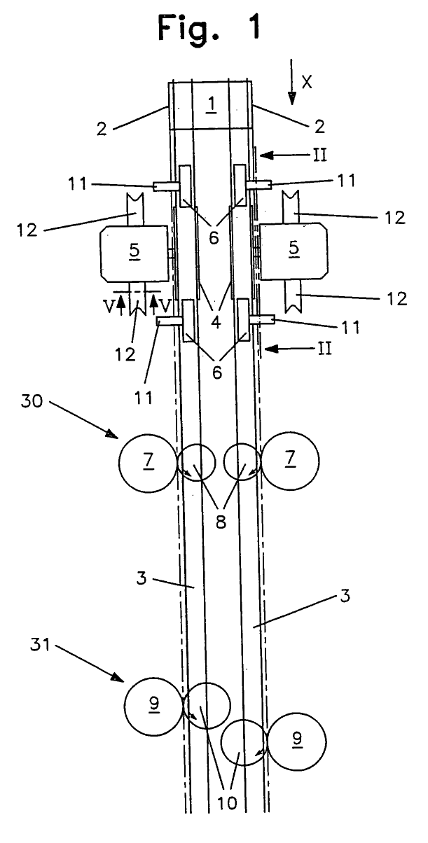

FIG. 1 top view of a cutout of a bag-making device in accordance with the invention

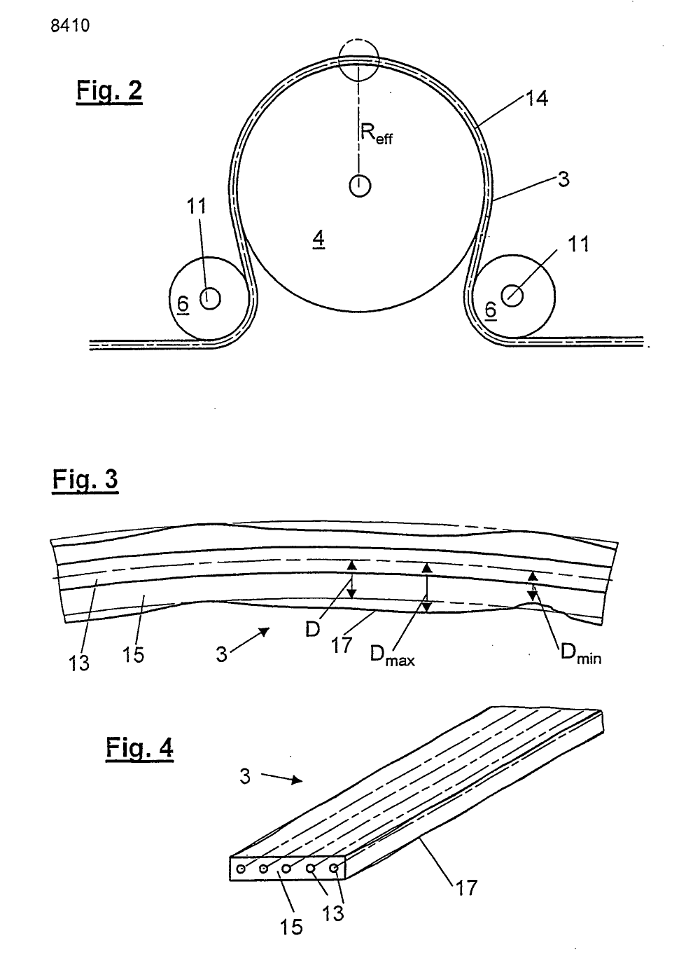

FIG. 2 side view in accordance with II-II in FIG. 1

FIG. 3 detailed view of the area circled in FIG. 2

FIG. 4 detailed view of a conveyor belt

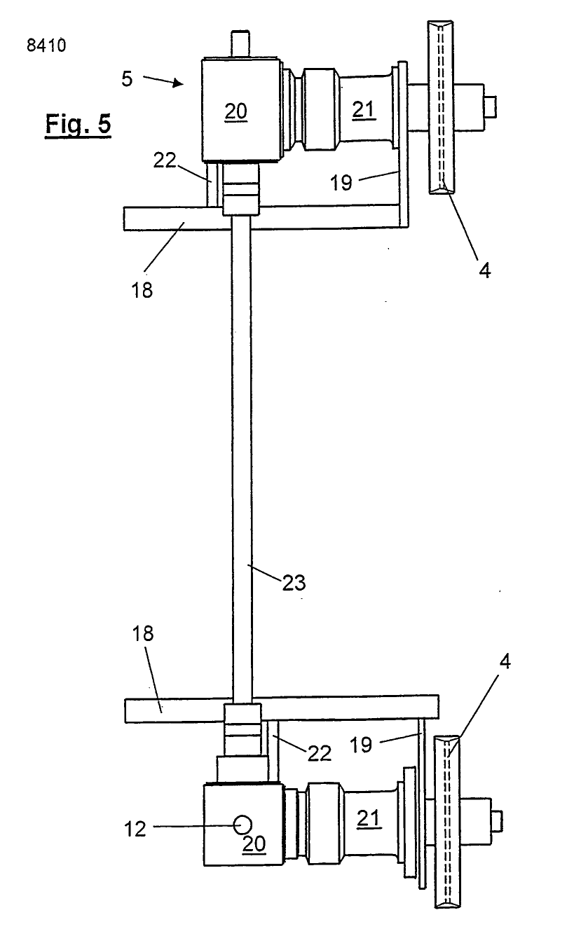

FIG. 5 gear configuration for the drive wheels in a bag-making device in accordance with the invention.

FIG. 1 illustrates a cutout of a bag-making device in accordance with the invention. The tube sections 1 are conveyed in a laid flat mode in the conveying direction x. The base 2 of the tube sections 1 were formed already. The formation of a bag base is described in e.g. another unpublished patent application of the same applicant with the application number DE-102 55 483. The tube section 1 is held gripped between the conveyor belts 3. As an example of two working stations existing in a bag making device, the base grooving station 30 and the gluing station 31 are described in the following. The tools designed as grooving knives that are attached on the circumference of the grooving rollers 7 of the base grooving station 30, provide the bases 2 of the tube section 1 with a base grooving whereby the back pressure rollers 8 provide the counteracting force. Subsequently an adhesive application in accordance with the format takes place in the gluing station 31 on the bases 2 of the tube sections 1 by the format rollers 9. The back pressure rollers 10 provide the counteracting force required for the adhesive application. All the rollers 7, 8, 9, 10 are supported in a manner that is not illustrated in detail in the machine frame (not illustrated).

The conveyor belt 3 is designed as an endless conveyor and entwines deflection rollers at both the ends of the bag-making device. The drive of the conveyor belt 3 takes place by the drive wheels 4. These are driven by the gears 5 that start from the line gear 12 and that are described in more detail on the basis of FIG. 5. In order to guarantee a sufficient adhesion of the conveyor belt 3 on the drive wheel 4, a deflection disc 6 is each arranged to the right and the left of every drive wheel 4 as can be seen in FIG. 2. These deflection discs 6 are pivoted over their bearing pins 11 in the machine frame.

The speed of the conveyor belt 3 and also the conveying speed of the tube sections 1 result from the distance covered per time unit. The distance covered however depends on the distance between the steel cord 13 of the conveyor belt 3 and the axis of the drive wheel 4. This distance is referred to as effective radius R_{eff} in the following. The effective radius R_{eff} is the sum of the radius of the drive wheel 5 and the thickness D of the rubber coat 15 between the steel cord 13 and the surface 17 of the conveyor belt 3. The surface 17 is in direct contact with the outer circumference of the drive wheel 5.

As can be seen in FIG. 3 the thickness D has no constant value, instead it varies between the values Dₘᵢₙ and Dₘₐₓ. In other words the distance D is afflicted with an error ΔD that results from the difference between Dₘₐₓ and Dₘᵢₙ. This error that results from the fabrication tolerances of the conveyor belt directly causes speed droops of the conveyor belt 3 and thus deficiencies in the fabrication quality of the cross base bags.

FIG. 4 illustrates a perspective view of the structure of the conveyor belt 3. The conveyor belt 3 essentially consists of several steel cords 13 that are arranged in a horizontal plane and a rubber coat 15 that surrounds the steel cords 13. Since the steel cords 13 have an essentially higher tensile strength as compared to the rubber coat 15, the steel cords 13 determine the so-called ‘neutral phase’ of the conveyor belt 3. This means that the steel cords 13 can neither be compressed nor can they be stretched. Conveyor belts 3 with a structure of such type are referred to in technology as ‘cable cord belts’ and can be kept narrow due to their tensile strength. They are thus particularly suitable for use in bag making devices that are used to manufacture cross base bags with a small base middle measurement. While using conveyor belts with a lower specific tensile strength, these bag making devices would have to be designed broader in order to receive a comparable tensile strength. The minimum base middle measurement that must be maintained increases accordingly.

FIG. 5 illustrates a view of the gear in accordance with FIG. 1. The drive torque is fed to the gear via, the line gear 12. The shaft pushes a bevel gear 20 that takes off a part of the torque moment and distributes it onto the planetary gear 21 and the shaft 23. The shaft 23 ends in another bevel gear 20 that deviates the torque moment and delivers it to another planetary gear 21. Both the planetary gears 21 each drive a drive wheel 4. All the gearbox parts 20, 21, 23 are connected to the base plates 18 or to the retaining plates 19, 22 whereby the retaining plates 19, 22 also are firmly connected to the base plates 18. The base plates 18 are attached to the machine frame in a manner not illustrated in more detail.

List of Reference symbols

| | |
|---|---|
| 1 | Tube section |
| 2 | Base |
| 3 | Conveyor belt |
| 4 | drive wheel |
| 5 | Gear |
| 6 | Deflection disc |
| 7 | Grooving roller |
| 8 | Back pressure roller |
| 9 | Format roller |
| 10 | Back pressure roller |
| 11 | Bearing pin |
| 12 | line gear |
| 13 | Steel cord |
| 15 | Rubber coat |
| 17 | Surface of the rubber coat 15 |
| 18 | Base plate |
| 19 | Retaining plate |
| 20 | Bevel gear |
| 21 | Planetary gear |
| 22 | Retaining plate |
| 23 | shaft |
| 30 | Base grooving station |
| 31 | Gluing station |
| R_{eff} | Effective radius |
| D | Thickness of the rubber layer |
| Dₘᵢₙ | Minimum thickness of the rubber layer |
| Dₘₐₓ | Maximum thickness of the rubber layer |
| x | Conveying direction |

1-5. (canceled)

6. A bag making device for cross base bags in which tube sections for the bags are processed, comprising a plurality of working stations that perform different working steps on the tube sections, at least one of the working stations being equipped with a tool that is mounted on a tool roller and that passes through its working position during each rotation of the tool roller at least one conveyor system that conveys the tube sections through the working stations, the conveyor system including cable cord belts that are driven by drive wheels having a larger diameter than the tool roller, and a drive system that drives the drive wheels and the tool roller such that one tube section passes through at least one working station each time the tool roller completes a rotation and such that the drive wheels have less angular speed than the tool roller.

7. The bag making device in accordance with claim 6, wherein a ratio of the angular speed of the drive wheels to the angular speed of the tool roller is 2:3 so that loss of tension associated with elongation of the cable cord belt during operation is reduced.

8. The bag making device in accordance with claim 6, wherein the drive wheels are driven by a transfer of torque from a line gear in communication with a bevel gear that is in communication with a planetary gear that is in communication with the drive wheel.

9. A method of processing tube sections in cross base bags, comprising
performing working steps on the tube sections in a plurality of working stations including in at least one working station performing a working step with a tool that is mounted on a rotating tool roller and that passes through its working position once during each rotation of the roller,
conveying the tube sections through the working stations with cable cord belts that are driven by drive wheels, and
driving the drive wheels with less angular speed than the tool roller such that one tube section passes through at least one working station each time the tool roller completes a rotation.

10. A method in accordance with claim 9, wherein a ratio of the angular speed of the drive wheels to the angular speed of the tool roller is 2:3.

11. A bag making device for processing a tube section of a cross base bag, comprising a station that performs a processing step on the tube section, the station having a tool that is mounted on a rotating tool roller such that the tool passes through a processing position during each rotation of the tool roller, a conveyor system that conveys the tube section through the station, the conveyor system including a cable cord belt that is driven by a drive wheel having a larger diameter than a diameter of the tool roller, and a drive system that drives the drive wheel and the tool roller such that the tube section passes through the station each time the tool roller completes a rotation and such that a ratio of an angular speed of the drive wheel to an angular speed of the tool roller is 2:3.

12. A device according to claim 11, further comprising a plurality of the stations that each performs a processing step on the tube section, and a corresponding plurality of tools mounted on a corresponding plurality of tool rollers.

13. A device according to claim 11, further comprising a pair of deflection wheels associated with the drive wheel, the deflection wheels providing tension on the cable cord belt so as to provide adhesion between the cable cord belt and the drive wheel.

14. A device according to claim 11, wherein the cable cord belt includes a plurality of tensile-stressable metal cords arranged in a horizontal plane and an elastic coating that surrounds the cords.

15. A device according to claim 14, wherein the metal cords have a higher tensile strength than the elastic coating.

16. A device according to claim 11, wherein the drive wheel is driven by a partial transfer of torque from a line shaft in communication with a bevel gear that is in communication with a planetary gear that is in communication with the drive wheel.
